(19) United States
(12) Patent Application Publication
(10) Pub. No.: US 2026/0295819 A1
(43) Pub. Date: Oct. 1, 2026

(54) GENERATIVE ARTIFICIAL INTELLIGENCE MODELS FOR CONTROLLING AUTONOMOUS SYSTEMS

(71) Applicant: QUALCOMM Incorporated, San Diego, CA (US)

(72) Inventors: Sanjay HARESH, Toronto (CA); Daniel Hendricus Franciscus DIJKMAN, Haarlem (NL); Apratim BHATTACHARYYA, San Diego, CA (US); Roland MEMISEVIC, Toronto (CA)

(21) Appl. No.: 19/091,409

(22) Filed: Mar. 26, 2025

Related U.S. Application Data
(60) Provisional application No. 63/652,788, filed on May 29, 2024.

(51) Int. Cl. B25J 9/16

(52) U.S. Cl. CPC B25J 9/163; B25J 9/1697

(57) ABSTRACT

Certain aspects of the present disclosure provide techniques and apparatus for controlling an autonomous device, such as a robot, using a machine learning model and for training such a model. An example method generally includes receiving an input (e.g., a multimodal input) indicating a task goal to perform using the autonomous device. The machine learning model identifies a first task to execute in order to perform the task goal and executes the first task. A reward metric is calculated by the machine learning model based on a comparison of a post-execution state of an environment in which the autonomous device is operating and a target state of the environment in which the autonomous device is operating. Based on the reward metric, the machine learning model identifies one or more second tasks to execute to perform the task goal described in the input.

### CROSS-REFERENCE TO RELATED APPLICATION

This application claims the benefit of U.S. Provisional Patent Application Serial No. 63/652,788, filed May 29, 2024, which is hereby incorporated by reference herein in its entirety for all applicable purposes.

### INTRODUCTION

### Field of the Disclosure

Aspects of the present disclosure relate to neural networks and machine learning.

### Discerption of Related Art

Robotic systems are used to perform a wide variety of tasks today. Additionally, the use of robots has increased substantially, and is expected to continue to increase. For example, robotic arms can be used to manipulate and move objects or to perform other actions, such as on a vehicle assembly line. As the desired tasks have expanded, the robotic control systems have similarly grown increasingly complex. Beyond controlling the positioning of robotic manipulators with high accuracy (which may include not only positioning and/or orientation of any end effectors such as graspers, but also of the other components of the arm itself), control systems may also obtain and use information about their environment. For example, before a robotic arm can be used to pick up objects in some cases, the control system may first determine an environmental context, such as where the objects are, how the objects are positioned/oriented, how the objects can be lifted, and/or the like.

### BRIEF SUMMARY

Certain aspects provide a processor-implemented method for training a machine learning model to control an autonomous device, such as a robot, to perform a plurality of tasks. The processor-implemented method generally includes generating a training dataset including a plurality of samples. Each of the plurality of samples includes a task that is performable by the autonomous device and that is mapped to one or more predicates that describe a successful attempt to perform the task. The processor-implemented method also includes training the machine learning model to control the autonomous device in accordance with an input indicating the plurality of tasks, based on the training dataset. The processor-implemented method further includes deploying the trained machine learning model.

Certain aspects provide a processor-implemented method for controlling an autonomous device, such as a robot, to perform a task goal. The processor-implemented method generally includes receiving an input indicating the task goal to perform using the autonomous device. The processor-implemented method also includes identifying, using the machine learning model, a first task to execute in order to perform the task goal. The processor-implemented method also includes executing the first task and, after executing the first task, calculating a reward metric based on a comparison of a post-execution state of an environment in which the autonomous device is operating and a target state of the environment in which the autonomous device is operating. The processor-implemented method further includes identifying, based on the reward metric and using the machine learning model, one or more second tasks to execute to perform the task goal.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for training a machine learning model to control an autonomous device, according to certain aspects of the present disclosure.

FIG. 2 depicts different examples of prompts that may be used to indicate a task goal, according to certain aspects of the present disclosure.

FIG. 3 depicts an example environment suite for generating a training dataset for training a machine learning model to control an autonomous device, according to certain aspects of the present disclosure.

FIG. 4 depicts an example compositional task design for a training dataset, according to certain aspects of the present disclosure.

FIG. 5 depicts an example simple manipulation task that may be included within a training dataset, according to certain aspects of the present disclosure.

FIG. 6 depicts an example intermediate task that may be included within a training dataset, according to certain aspects of the present disclosure.

FIG. 7 depicts an example complex task that may be included within a training dataset, according to certain aspects of the present disclosure.

FIG. 8 is a flow diagram of example operations for training a machine learning model to control an autonomous device to perform a task goal, according to certain aspects of the present disclosure.

FIG. 9 illustrates an example visualization of a machine learning model trained to control an autonomous device to perform a task goal, according to certain aspects of the present disclosure.

FIG. 10 illustrates an adaptation of a base machine learning model to perform tasks using an autonomous device, according to certain aspects of the present disclosure.

FIG. 11 is a flow diagram of example operations for controlling an autonomous device to perform a task goal identified in a multimodal input prompt into a machine learning model, according to certain aspects of the present disclosure.

FIG. 12 depicts an example processing system configured to perform various aspects of the present disclosure.

FIG. 13 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Certain aspects of the present disclosure provide apparatuses, methods, processing systems, and computer-readable mediums for training and using machine learning models to control autonomous devices, such as robots, within a physical environment to perform a sequence of tasks associated with a task goal. The task goal, for example, may be identified in a multimodal input into a trained machine learning model, and the sequence of tasks associated with the task goal may be identified using the trained machine learning model.

Complex manipulation tasks performed, for example, by a robot or other autonomous system typically include several steps. Each of these steps is generally based on knowledge of the physical environment in which a robot is located and possible interactions that may occur with objects in the physical environment. For example, the task of preparing a kettle of hot water involves several sub-tasks, including grasping the kettle, moving the kettle into the sink, turning the faucet on to let water flow into the kettle, turning the faucet off when the kettle is sufficiently filled, placing the kettle onto a burner, and turning the knob of the correct burner, with each task being preconditioned on the successful execution of a prior task. Various types of neural networks can be implemented to process data characterizing a physical environment in order to enable a device, such as a robot, to perform these types of tasks within the physical environment. For example, neural networks may process visual content (e.g., image data, such as still images, and/or video data, such as streams of images) to detect objects, predict future motion of objects detected in visual content, segment visual content into different semantic groups, etc.

Machine learning models can be used to control robots or other autonomous systems to perform various tasks within a physical environment. However, these machine learning models may have various drawbacks that limit the ability to train a robust model that is generalizable across various tasks or physical environments. For example, some machine learning models used in controlling robots or other autonomous systems may not be able to control a robot or other autonomous system according to a natural language prompt defining an action to perform or an end state of the environment in which the robot or autonomous system is operating. In another example, some machine learning models may have a limited, fixed set of tasks which the model can perform, and thus may not be generalizable across different environments, different autonomous systems, and the like. Such models may be trained to perform actions within certain environments, but may not be able to generalize the performance of these actions across different environments.

Machine learning models used in controlling robots or other autonomous systems can identify commands to execute in order to perform a specified task. Generally, these machine learning models may not operate on natural language commands or prompts into these machine learning models, but instead may operate based on model-specific inputs that identify objects on which an action is to be performed and the like. These machine learning models, however, may not provide a natural input mechanism for users to interact with robots or other autonomous systems to cause various tasks to be performed by a robot or other autonomous system within a given environment.

Certain aspects of the present disclosure provide techniques for training and using machine learning models to control robots or other autonomous systems to perform a task goal identified, indicated, or implied by an input prompt (e.g., natural language input prompt, multimodal input prompt, etc.). As discussed below in further detail, a machine learning model may be trained based on a training dataset that includes (i) various task components, which may be components of a larger overall task goal, and (ii) associated predicates identifying a successful end state for executing the task goal. The machine learning model may be trained to generate a sequence of tasks to perform in order to achieve an end state identified or implied by a prompt input into the machine learning model in an autoregressive manner (such that the identification of a task to perform using the autonomous system is conditioned on previous tasks executed by the autonomous system and the current state of the environment in which the autonomous system operates, as defined by a reward metric calculated for a specific task component executed by the autonomous system).

By training a machine learning model to control a robot or other autonomous system based on tasks and associated predicates identifying a successful end state for the task goal, certain aspects of the present disclosure may provide for the training and use of machine learning models that are generalizable across various types of robots and various operating environments, as opposed to being tightly bound to specific robots and/or specific operating environments. Additionally, certain aspects of the present disclosure may allow a machine learning model to learn to decompose complex, multi-step, tasks into a plurality of base tasks to be executed in sequence in order to perform the complex task. The machine learning model may thus need not be trained to specifically perform complex tasks according to defined sequences of tasks, but instead may learn to identify a sequence of tasks (which may be specific to a robot and/or operating environment of the robot) to perform in order to execute more complex tasks.

### Example Workflow for Training a Machine Learning Model to Control Autonomous Devices

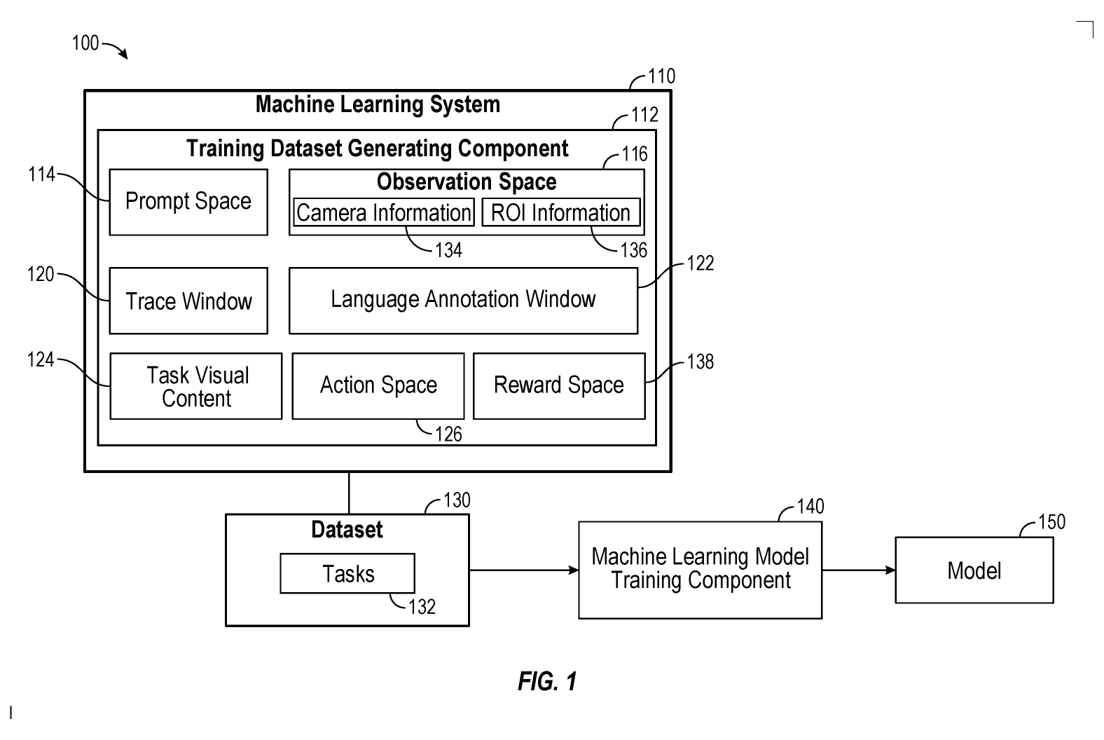

FIG. 1 depicts an example workflow 100 for training a machine learning model to control an autonomous device, according to certain aspects of the present disclosure.

In the depicted workflow 100, a machine learning system 110 generates a training dataset 130 for training one or more machine learning models. For example, a machine learning model training component 140 may use the training dataset 130 to train a machine learning model 150 to perform a task goal involving a sequence of tasks. As used herein, a “task goal” generally refers to an overall action objective, which may involve one or more tasks to complete the objective. In certain aspects, the machine learning model 150 is a generative artificial intelligence model. Although a single (trained) machine learning model 150 is depicted for conceptual clarity, in certain aspects, the workflow 100 may be used to train multiple machine learning models, each configured to perform a respective task goal.

The operations of the machine learning system 110 and/or the machine learning model training component 140 may be implemented using hardware, software, or a combination of hardware and software. Additionally, although the machine learning system 110 and the machine learning model training component 140 are depicted separately for conceptual clarity, in some aspects, the operations of the machine learning model training component 140 may be implemented by the machine learning system 110. In general, the operations of the machine learning system 110 and/or the operations of the machine learning model training component 140 may be implemented by one or more (or a combination of) computing systems.

As depicted, the machine learning system 110 includes, without limitation, a training dataset generating component 112, which is configured to generate the training dataset 130, for example, using one or more techniques described herein. In certain aspects, the training dataset generating component 112 may provide a simulation environment suite (including multiple components) for generating the training dataset 130, which can be used as a benchmark (e.g., standardized dataset(s)) for training autonomous devices to perform compositional task goals. For example, as described in greater detail herein, the training dataset 130 may include data associated with multiple tasks 132 of varying levels of compositionality. As an illustrative example, the tasks 132 may include (i) low level (or simple) tasks designed to teach the autonomous device basic motor/manipulation skills (e.g., move from A to B, pick, place, push, trace path, etc.) (referred to herein as level 0 (L0) tasks), (ii) intermediate tasks involving simple compositions of skills learned from the L0 tasks (e.g., sort objects by texture, stack, etc.) (referred to herein as level 1 (L1) tasks), and (iii) complex tasks involving complex compositions of skills learned from the L0 and L1 tasks (e.g., stack and topple structures, sort by throwing, balance scales with weights, etc.) (referred to herein as level 2 (L2) tasks). Note that while certain aspects herein refer to tasks 132 having three levels of compositionality (e.g., L0, L1, and L2) for conceptual clarity, it should be noted that tasks 132 may include any number of levels of compositionality (e.g., two levels, three levels, or greater than three levels).

As depicted in FIG. 1, the training dataset generating component 112 includes, without limitation, a prompt space 114, an observation space 116, a trace window 120, a language annotation window 122, a task visual content 124, an action space 126, and a reward space 138. The training dataset generating component 112 may use one or more of (or a combination of) the prompt space 114, the observation space 116, the trace window 120, the language annotation window 122, the task visual content 124, the action space 126, and the reward space 138 to monitor actions performed by an agent (e.g., autonomous device, such as a robot) in an environment (e.g., simulated environment) in order to determine whether an action succeeded in performing a given task (e.g., a task 132) or at least made progress in performing the given task. For each task, the training dataset generating component 112 may collect, generate, or obtain information associated with the monitoring for the task, and may include such information within the training dataset 130.

The prompt space 114 is generally configured to accept or otherwise obtain a prompt or other input that indicates the (desired) end state of the task (e.g., a task specification) or task goal. The prompt space 114 may support input prompts that include data in one or more (or a combination of) modalities. The modalities may include visual data (e.g., images, videos, graphical representations, etc.), textual (or text) data, auditory data (e.g., speech, ambient sounds, music, etc.), and/or haptic data, among other data types.

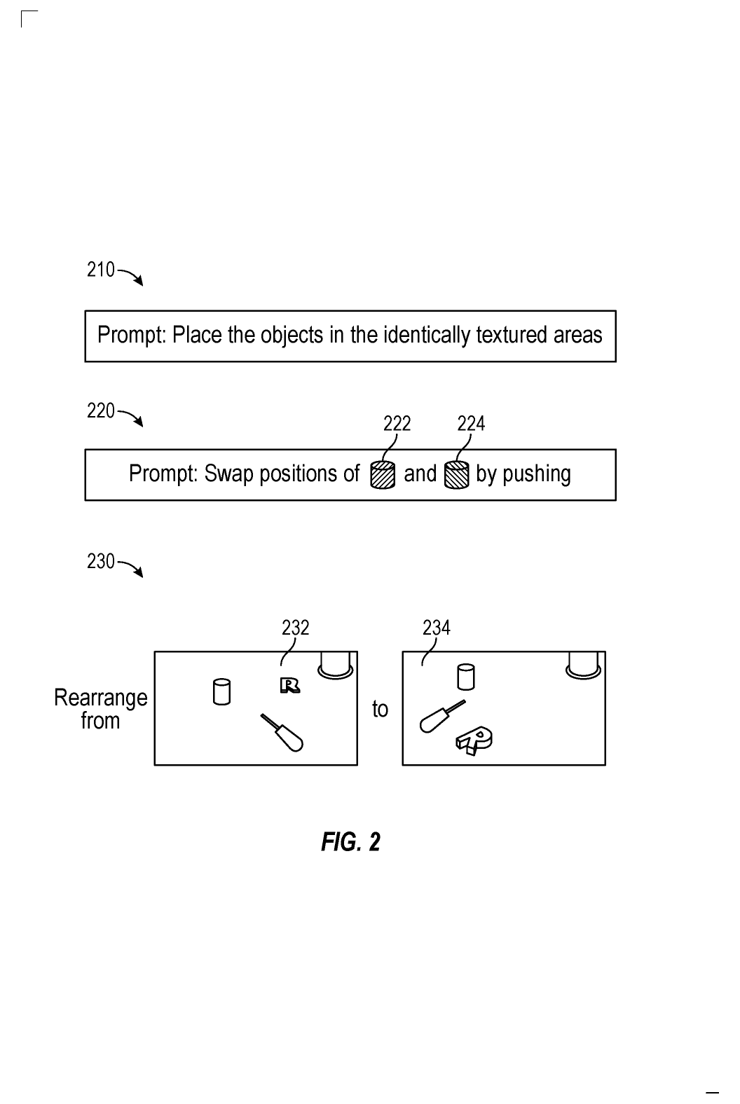

For example, prompt 210 depicted in FIG. 2 is an example of a natural language text-only prompt that includes solely natural language text. Here, the prompt 210 uses text to describe a set of actions to perform (including the desired end state of the set of actions) as well as the objects within the operating environment of the agent (e.g., autonomous device, such as a robotic arm or other autonomous system) on which the set of actions is to be performed.

In another example, prompt 220 depicted in FIG. 2 is a multimodal prompt that includes natural language text and image data (e.g., image 222 and image 224). The natural language text of prompt 220 describes a set of actions to perform. The image data of prompt 220 identifies one or more objects within the operating environment of the agent on which the set of actions is to be performed (e.g., the object associated with image 222 is to be swapped with the object associated with image 224).

In yet another example, prompt 230 depicted in FIG. 2 is a multimodal prompt that includes natural language text and image data (e.g., image 232 and image 234). The natural language text of prompt 230 describes a set of actions to perform. The image data of prompt 230 identifies one or more objects within the operating environment of the agent on which the set of actions is to be performed as well as a desired end state of the set of actions (e.g., the objects associated with image 232 are to be rearranged according to image 234).

The prompt space 114 may be configured to accept prompts in one or more (of a combination of) modalities for a wide variety of tasks ranging from simple tasks (e.g., L0 tasks) to complex tasks (e.g., L2 tasks). For example, the prompt for a pick task (e.g., L0 task) may be expressed with “pick up the [obj:object],” where [obj:object] is an image placeholder, natural language text, or some other datatype representative of the object on which the “pick” task is to be performed. In another example, the prompt for an intermediate task (e.g., L1 task) may be expressed with “put [obj:object]₁ on [obj:object]₂,” where [obj:object]₁ is an image placeholder, natural language text, or some other datatype representative of the first object and [obj:object]₂ is an image placeholder, natural language text, or some other datatype representative of the second object. In yet another example, the prompt for a stack topple task (e.g., L2 task) may be expressed with “stack [obj:object]₁ on [obj:object]₂ and then topple the stack,” where [obj:object]₁ is an image placeholder, natural language text, or some other datatype representative of the first object and [obj:object]₂ is an image placeholder, natural language text, or some other datatype representative of the second object. In certain aspects, at least a portion of the prompts described herein may be generated based on a base set of prompts or code snippets that are transformed into natural language prompts using a trained large language model (LLM) or large multimodal model (LMM).

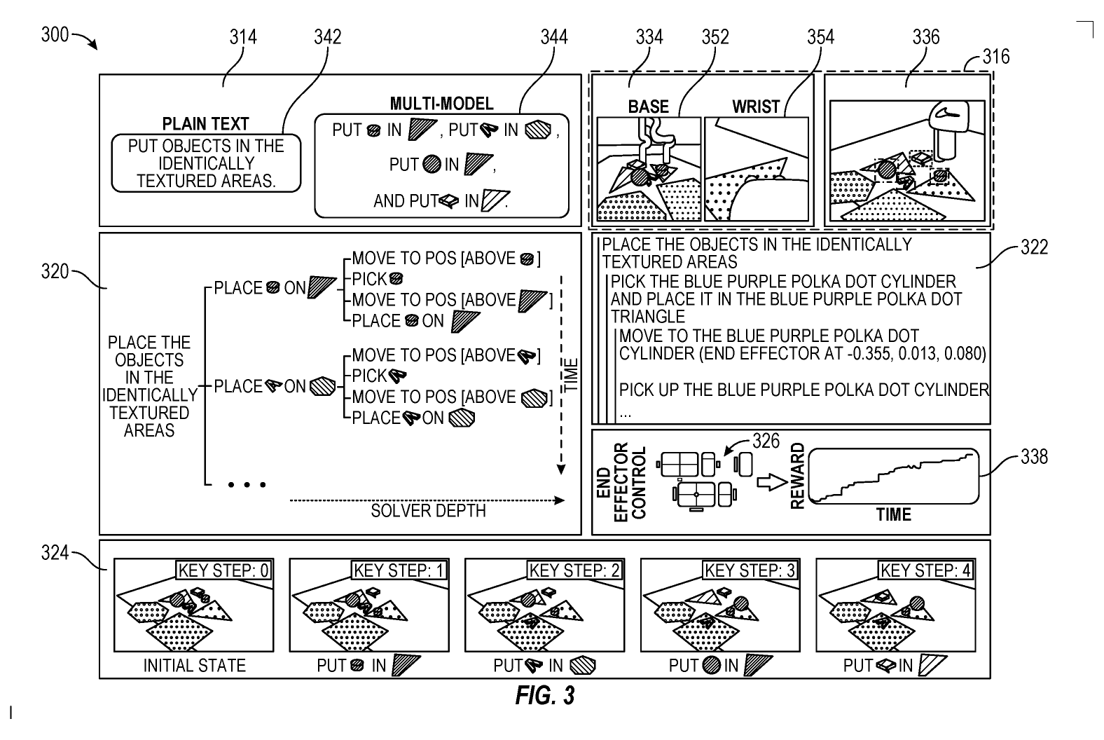

FIG. 3 depicts an example of a prompt space 314 that may be included within an environment suite 300 generated by the training dataset generating component 112. Here, the prompt space 314 may be an illustrative implementation of the prompt space 114 depicted in FIG. 1. As shown, the prompt space 314 may support (or accept) a prompt 342 that includes solely text and/or a multimodal prompt 344 that includes text (e.g., natural language text) and image data.

Referring back to FIG. 1, in certain aspects, a task (e.g., individual task or composite task) may be defined as a set of predicates, which specifies the reward and success criteria for the task. For example, each predicate may have the ability to evaluate whether the agent successfully performed a given task and may generate a reward metric (or reward signal) based on which subsequent action(s) can be identified and performed. A predicate may, for example, define relationships between different objects in the environment in which the agent executes. Predicates may also or alternatively define logical relationships between objects or actions performed with respect to these objects in the environment in which the agent operates. Generally, a task may include a set of chained predicates, each of which should be satisfied in order for the task to have been deemed to be performed correctly.

Various types of predicates may be supported, including elementary (or physical) predicates and logical predicates. An elementary predicate may specify the target state of the agent, the target state of the object(s) in the operating environment of the agent, how the agent achieves the target state of the agent, how the agent achieves the target state of the object(s) in the operating environment of the agent, or any combination thereof. For example, the elementary predicates EEAtPos (end effector at position) and EEAtPose (end effector at pose) may specify a target position of the agent and a target pose of the agent, respectively. In another example, the elementary predicates AtPos (at position) and AtPose (at pose) may specify a target position and a target pose of an object, respectively. In yet another example, the elementary predicates OnTop and Inside may specify that an object is to be on top of another object and inside another object, respectively. In yet another example, the elementary predicate Hit may specify that the agent is to drop an object onto another object or knock over an object or stack of objects. In yet another example, the elementary predicate ToppleStructure may specify that a collection of objects is to be on the ground.

Logical predicates may be used to combine elementary predicates in order to specify more complex (e.g., compositional) tasks. For example, the logical predicate Set may indicate that all sub-predicates (e.g., elementary predicates) can be completed in any order. In another example, the logical predicate Sequence may indicate that sub-predicates are to be completed in order. In yet another example, the logical predicate Once may indicate that a sub-predicate is to completed once. The reward metric generated by elementary predicates may allow agents to learn tasks. Each logical predicate may aggregate the rewards of the sub-predicates associated with the logical predicate as appropriate. The decomposition of tasks into predicates may allow for the training dataset 130 to be easily extendable since new tasks can be easily specified as compositions of these predicates.

The environment provided by the training dataset generating component 112 may be a simulated environment, also known as a reinforcement learning (RL) gymnasium (GYM). Within the simulated environment, actions performed by an agent in the environment may be monitored in order to determine whether an action succeeded in performing a given task or at least made progress in performing the given task. A reward metric associated with a set of predicates corresponding to the task may be defined for use in determining whether the agent has successfully performed the task. In some aspects, the reward metric may be a floating-point number between 0.0 and 1.0, with higher values for the reward metric (values closer to 1.0) corresponding to the performance of actions that more closely approaches a desired end state and lower values for the reward metric (values closer to 0.0) corresponding to the performance of actions that does not accomplish the desired end state. Additionally or alternatively, in some aspects, the reward metric may include a Boolean value (e.g., “True”) to indicate success of performance of an action and a Boolean value (e.g., “False”) to indicate failure of performance of an action. The reward metric may be shown or otherwise indicated in the reward space 138. By way of example, FIG. 3 depicts an example reward space 338 that may be provided within the environment suite 300 for performance of the task goal indicated by prompts 342 and/or 344, according to certain aspects of the present disclosure. The reward space 338 may be an illustrative example of the reward space 138 depicted in FIG. 1.

In certain aspects, solvers indicating how to successfully perform the respective set of predicates associated with a given task may be defined. These solvers may be defined a priori for different tasks. In some cases, these solvers may include demonstrations, such as videos of humans performing a particular task, which can be used to train a machine learning model to perform the respective set of predicates for a particular task using imitation learning techniques. In some cases, these solvers may be “oracles” that can observe the state of the environment in which an agent is deployed in order to define how a task can be performed. In certain aspects, a top-level solver algorithm may perform a search for the next predicate to solve and may instantiate a solver (or solver policy) corresponding to the next predicate. The mapping from a predicate to a specific solver (e.g., Pick, Place, Move, Trace, Touch, Push, Hit (throw object towards another object), ToppleStructure, BalanceScale (place objects on a scale to balance the scale), among others) may be a priori defined. One or more of the solvers may be based on a motion planning library, such as MPLib, as an illustrative example. Higher-level solvers may use other solvers internally. For example, the PickMovePlace solver may internally use Move to get the end effector close to a position where the end effector can pick up the object, use Pick to pick up the object, use Move to carry the object close to a target, and use Place to place the object. A solver may allow its respective sub-solvers to take actions in the environment until each sub-solver reports that the sub-solver has completed the action or has failed. In some implementations, solver policies are stateless, such that the solver policies can be combined with other policies (e.g., a solver policy can start collecting oracle solver trajectories from states that were reached by an agent to perform fine-tuning for execution of another complex task).

In certain aspects, these solvers can generate a trace illustrating actions performed in order to perform the task associated with a solver. The generated trace may be indicated in the trace window 120. The trace may be used as annotations from which a machine learning model is trained to learn how to perform tasks of varying complexity. In some aspects in which the solver is programmatically defined (e.g., defined as an executable computer script), the annotations may be included in a log file or other historical trace data that describes each action and each stage of a demonstration of a task. In some aspects in which the solver is defined as a recording of a human performing a particular task, the annotations may be structured as a natural language narration of the activities that the human is performing. Such natural language annotations may be indicated in the language annotation window 122. By way of example, FIG. 3 depicts an example trace window 320 and an example language annotation window 322 that may be provided within the environment suite 300 for performance of the task goal indicated by prompts 342 and/or 344, according to certain aspects of the present disclosure. The trace window 320 may be an illustrative example of the trace window 120 depicted in FIG. 1, and the language annotation window 322 may be an illustrative example of the language annotation window 122 depicted in FIG. 1.

In certain aspects, multiple levels of the trace may be depicted in the trace window 320. For example, the trace window 320 includes a task goal level (e.g., the highest level describing the task goal, which can also be used as the task specification), a logical predicate level indicating a set of logical predicates associated with the task goal, and a sub-predicate level indicating, for each logical predicate, a set of elementary predicates associated with the logical predicate. Additionally or alternatively, in certain aspects, multiple levels of the language annotations may be depicted in the language annotation window 322. For example, the language annotation window 322 includes a task goal level (e.g., the highest level describing the task goal, which can also be used as the task specification), a sub-task level (e.g., a sub-task on a semantic level that has to be achieved for the task goal to be completed), and a step level (e.g., a language label for each step that is being taken).

Referring back to FIG. 1, the observation space 116 provides information associated with an observation of the environment. Such information may include camera information 134 (e.g., image data and/or video data from one or more cameras in the environment, camera parameters, etc.), region of interest (ROI) information 136, and/or agent pose and velocity information, as illustrative examples. In certain aspects, assuming the agent is a robotic arm end effector, the camera information 134 may include (i) image data from a camera mounted on the robotic arm end effector that gives the robotic arm’s “first-person” view of the environment and (ii) image data from a base camera that provides a “third-person” perspective.

The ROI information 136 may include a respective ROI(s) of an object(s) within the environment. Each ROI, for example, may be an approximate region of an image (from a camera within the environment) where an object is located. The ROI of a given object may be indicated with a “bounding box” around the object. The “bounding box” may have various shapes, such as rectangles, circles, or triangles, as illustrative examples. In certain aspects, the observation space 116 may indicate ROI information 136 for each object at each time step of the generated trajectory for each task.

By way of example, FIG. 3 depicts an example of an observation space 316 that may be provided within the environment suite 300 for performance of the task goal indicated by prompts 342 and/or 344, according to certain aspects of the present disclosure. The observation space 316 may be an illustrative example of the observation space 116 depicted in FIG. 1. Here, the observation space 316 includes (i) camera information 334, which includes an image 352 captured from a base camera of an agent and an example image 354 captured from a camera mounted on the agent, and (ii) ROI information 336, which includes one or more ROIs (e.g., bounding boxes) for one or more objects within the operating environment of the agent. The camera information 334 may be an illustrative example of the camera information 134 depicted in FIG. 1, and the ROI information 336 may be an illustrative example of the ROI information 136 depicted in FIG. 1.

Referring back to FIG. 1, the action space 126 may include an indication of pose deltas of the agent (e.g., robotic arm), and/or gripper commands for the agent. For example, the action space 126 may indicate the gripper commands, pose deltas of the agent, and object poses corresponding to the action trajectory of the agent in performing a task. The pose delta of the agent may include the agent’s position and orientation in multiple degrees of freedom (DOF) (e.g., 3 DOF, 6 DOF, etc.). In certain aspects, the action space 126 may indicate the object poses, pose deltas of the agent, and gripper commands for the agent at each time step of the generated trajectory for each task.

By way of example, FIG. 3 depicts an example action space 326 that may be provided within the environment suite 300 for performance of the task goal indicated by prompts 342 and/or 344, according to certain aspects of the present disclosure. The action space 326 may be an illustrative example of the action space 126 depicted in FIG. 1.

Referring back to FIG. 1, the task visual content 124 may include visual content (e.g., image data, video data, etc.) corresponding to the completion of each (sub)-task associated with a task goal. By way of example, FIG. 3 depicts an example task visual content 324 that may be provided within the environment suite 300 for performance of the task goal indicated by prompts 342 and/or 344, according to certain aspects of the present disclosure. As shown, the task visual content 324 includes five key-step frames corresponding to the completion of five sub-tasks associated with performance of the task goal indicated by prompts 342 and/or 344.

In certain aspects, the training dataset 130 may include various information associated with monitoring actions associated with one or more tasks 132 performed by the agent in the environment. For example, as noted, the training dataset 130 may include, for each task 132, videos of an agent (e.g., simulated robot) performing and accompanying actions taken by the agent, multimodal prompts for the task specification, language annotations for agent actions, ROI information of objects (e.g., object bounding boxes), and visibility annotations and frames of key-steps. In certain cases, the actions taken by the agent may be in the form of a matrix representing an action trajectory of the robot. Such a matrix, for example, may be an NxM matrix, where N is the number of frames and M is the dimension of the action vector (e.g., M = 7). In general, the training dataset 130 may include, for each task 132, (i) visual content (e.g., image data and/or video data obtained from camera(s) in the environment) of the agent performing the task 132, (ii) action trajectories of the agent, (iii) action labels (e.g., a text label for each action step), (iv) camera parameters for each camera in the environment, (v) task specification/prompts/inputs, (vi) predicates, (vii) solvers (including trace information), (viii) annotations, (ix) task visual content (e.g., images of key steps of the task 132), (x) images used in the prompts, (xi) a reward for each step performed for the task 132, and/or (xii) a label indicating if the task 132 was successful or not at each time step, among other information.

As shown in FIG. 1, the machine learning model training component 140 may use the training dataset 130 to train one or more machine learning models 150 to perform one or more respective task goals in a real-world environment and/or evaluate one or more trained machine learning models 150 in performing one or more respective tasks goals. That is, the action trajectories, tasks 132, predicates, prompts/inputs, visual content, and solvers, among other information, included in the training dataset 130 may be used in various training and evaluation operations for generative artificial intelligence models that generate control signaling to instruct autonomous systems to perform tasks in the real-world environment. The machine learning model training component 140 may employ any one of (or combination of) training techniques to train the machine learning model 150 to perform a task goal in a real-world environment. Such training techniques may include reinforcement learning, imitation learning, supervised learning, and/or deep learning, as illustrative examples.

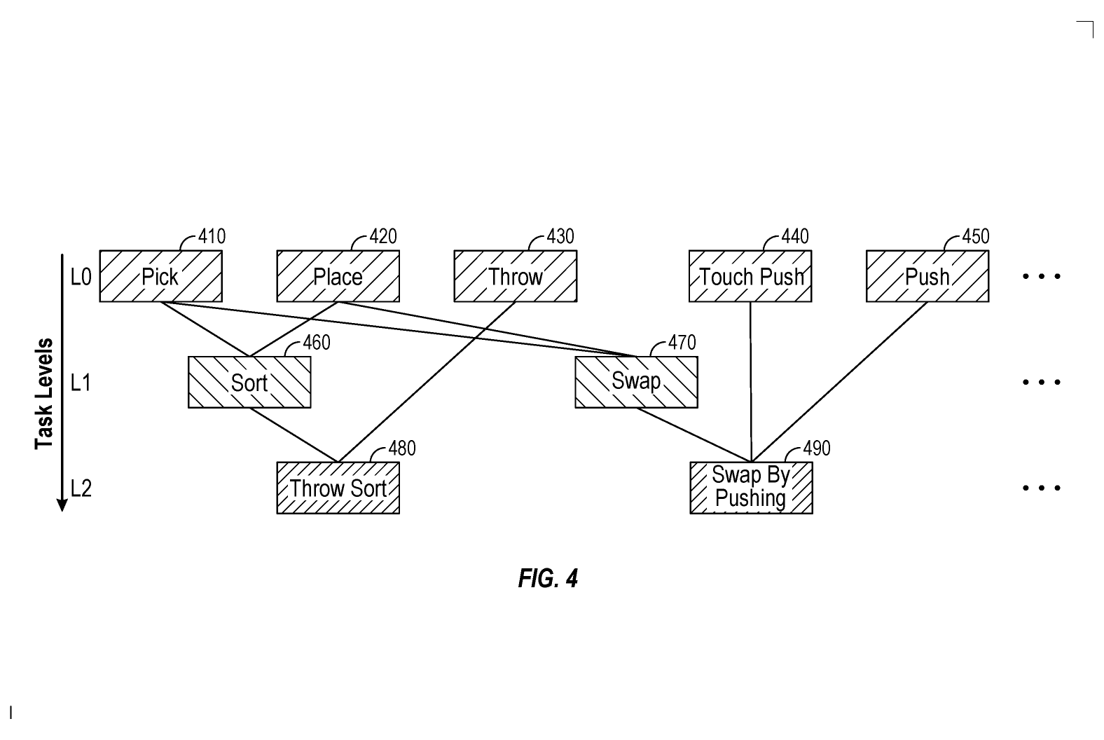

As noted, the tasks 132 within the training dataset 130 may be associated with varying levels of compositionality. The tasks 132 may be designed to test compositional generalization of robotics models. By way of example, FIG. 4 depicts an example compositional task design 400 with multiple tasks 132 that may be included within the training dataset 130, according to certain aspects of the present disclosure. Here, the compositional task design 400 includes simple manipulation tasks (e.g., L0 tasks, such as a pick task 410, a place task 420, a throw task 430, a touch push task 440, and a push task 450), intermediate tasks (e.g., L1 tasks, such as a sort task 460 and a swap task 470), and complex tasks (e.g., L2 tasks, such as a throw sort task 480 and a swap-by-pushing task 490). The simple manipulation tasks within the training dataset 130 may allow a machine learning model 150 trained on the training dataset 130 to learn basic manipulation/motor skills. Additionally, the intermediate tasks within the training dataset 130 may test the trained machine learning model 150’s ability to compose the manipulation skills learned from the simple manipulation tasks. Further, the complex tasks within the training dataset 130 may test higher-level compositional reasoning of the trained machine learning model 150.

For example, for each of the sort task 460 and the swap task 470, the trained machine learning model 150 may have to use a picking skill learned from the pick task 410 and a placing skill learned from the place task 420 and then compose these two skills to solve the sort task 460 and the swap task 470. In another example, for the throw sort task 480 (e.g., sort-by-throwing task), the trained machine learning model 150 may have to use a throwing skill learned from the throw task 430 and a sorting skill learned from the sort task 460 and then compose these two skills to successfully solve the throw sort task 480. In another example, for the swap-by-pushing task 490, the trained machine learning model 150 may have to use a touch-by-pushing skill learned from the touch push task 440, a pushing skill learned from the push task 450, and a swapping skill learned from the swap task 470 and then compose these three skills to successfully solve the swap-by-pushing task 490.

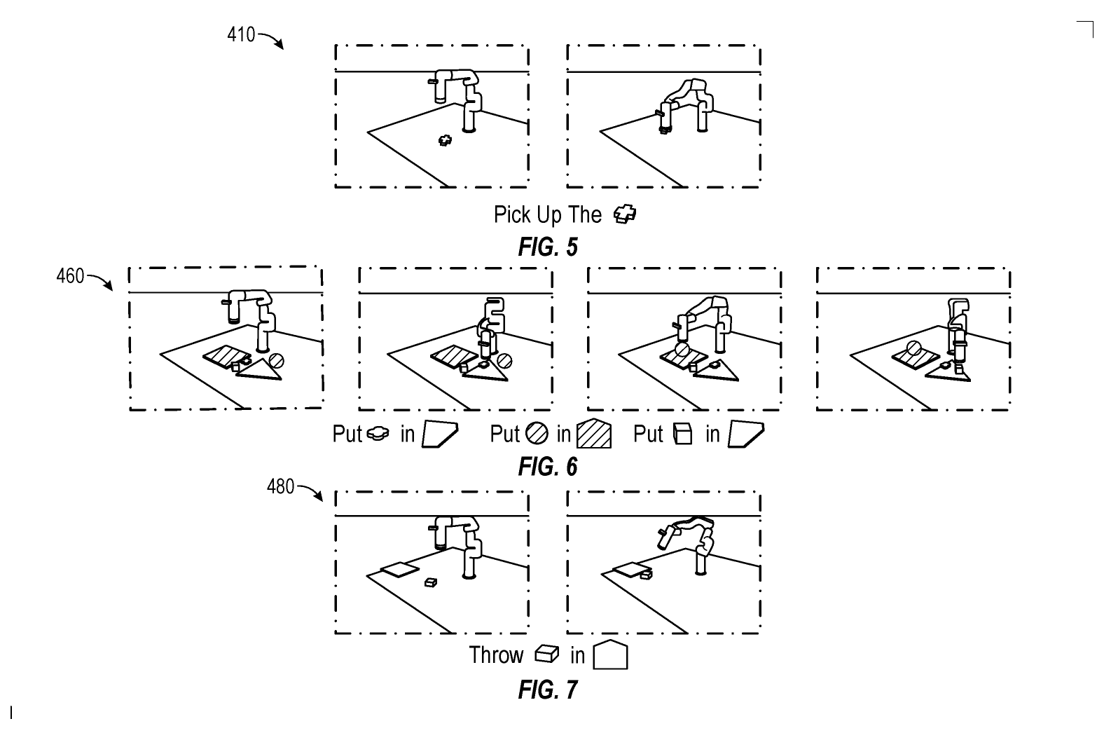

FIGS. 5-7 depict examples of a simple manipulation task (e.g., L0 task), an intermediate task (e.g., L1 task), and a complex task (e.g., L2 task), respectively, according to certain aspects of the present disclosure. In particular, FIG. 5 depicts visual content of steps associated with a pick task 410 along with a multimodal prompt for the pick task 410, FIG. 6 depicts visual content of steps associated with a sort task 460 along with a multimodal prompt for the sort task 460, and FIG. 7 depicts visual content of steps associated with a throw sort task 480 (e.g., sort-by-throwing) along with a multimodal prompt for the throw sort task 480.

In FIG. 5, the multimodal prompt for the pick task 410 is expressed with “pick up the [obj:object],” where [obj:object] is an image placeholder that is indicative of (or otherwise associated with) the object that is to be picked up. In some cases, the multimodal prompt for the pick task 410 may also be expressed with “grab the [obj:object],” “lift the [obj:object],” “pick up the object with [tex:object] texture,” “grab the object with [tex:object] texture,” or “lift the object with [tex:object] texture.” Performing the pick task 410 may involve the agent picking up the object shown in the image placeholder [obj:object] or picking up the object having the texture shown in [tex:object]. To increase the difficulty of the pick task 410, one or more additional objects (not shown) may be introduced in the operating environment of the agent. The pick task 410 may be considered to be successfully completed when the specified object is picked up (e.g., attached to the agent (end effector) and not touching the ground).

In FIG. 6, the multimodal prompt for the sort task 460 may be expressed with “put [obj:object]₁ in area with [tex:object]₁ texture, put [obj:object]₂ in area with [tex:object]₂ texture, put [obj:object]₃ in area with [tex:object]₃ texture.” Alternatively, in some cases, the sort task 460 may be indicated with a natural language prompt expressed, e.g., with “place the objects in the identically textured areas.” Performing the sort task 460 may involve the agent placing each object in the respective area with similar texture as the object. The sort task 460 may be considered to be successfully completed when all the objects are placed in the areas that have the same texture as the objects.

In FIG. 7, the multimodal prompt for the throw sort task 480 may be expressed with “throw [obj:object] in area with [tex:object] texture.” Alternatively, in some cases, the throw sort task 480 may be indicated with a natural language prompt expressed, e.g., with “place the object in the identically textured area by throwing.” Performing the throw sort task 480 may involve the agent picking and throwing the object into the specified area. To force the agent to use the throwing skill (e.g., as opposed to sort by picking and place skill), the area with the same texture as the object may be positioned out of reach of the agent, such that the task cannot be completed without throwing. The throw sort task 480 may be considered to be successfully completed when the object is placed in the area that has the same texture as the object and the object is “thrown” in the area instead of “placed” in the area.

### Example Operations for Training and Using Machine Learning Models for Controlling Autonomous Devices

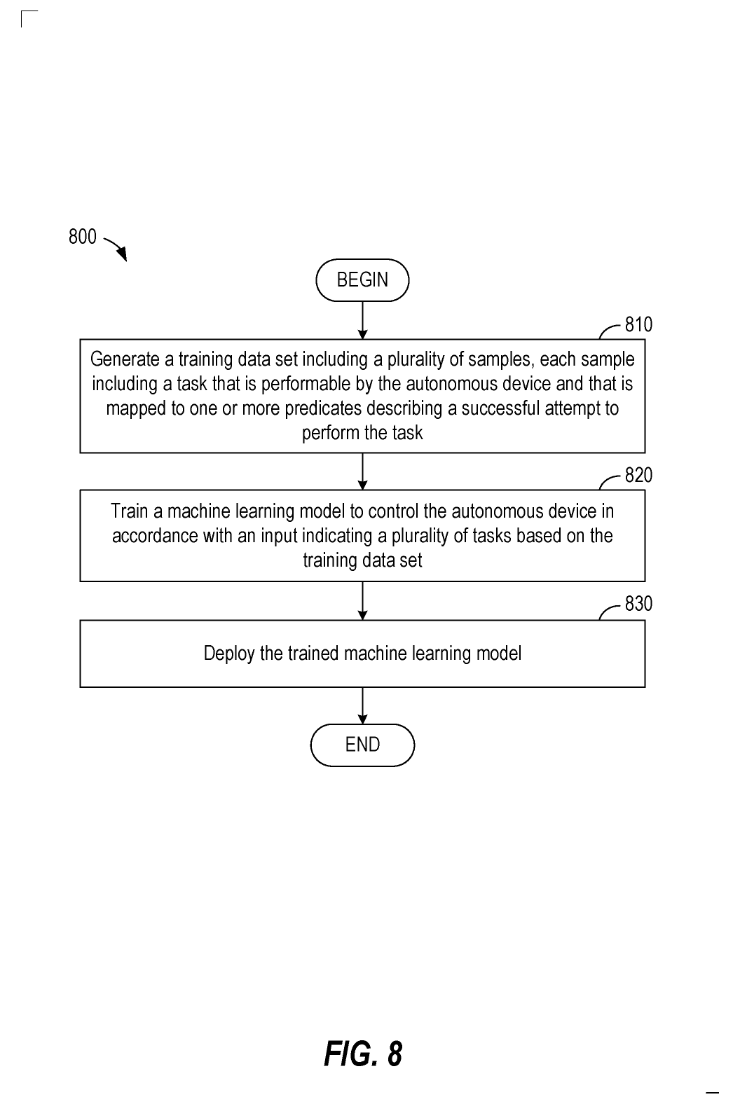

FIG. 8 illustrates example operations 800 for training a machine learning model to control an autonomous device to perform a task goal identified in an (multimodal) input, according to certain aspects of the present disclosure. The operations 800 may be performed on a computing device on which a machine learning model may be trained, such as a server computer, a cluster of physical computing instances, one or more cloud computing instances, or the like.

As illustrated, the operations 800 begin at block 810 with generating a training dataset (e.g., training dataset 130) including a plurality of samples. Generally, each sample may include at least a task (e.g., task 132) that is performable by the autonomous device and that is mapped to one or more predicates describing a successful attempt to perform the task.

At block 820, the operations 800 proceed with training a machine learning model (e.g., machine learning model 150) to control the autonomous device in accordance with an input indicating (e.g., a prompt including) a plurality of tasks, based on the training dataset.

At block 830, the operations 800 proceed with deploying the trained machine learning model.

In certain aspects, the input includes a natural language prompt (e.g., prompt 342) generated using a trained large language model.

In certain aspects, the one or more predicates are associated with a reward function associated with the task. The reward function may be defined to generate a value between a defined lower bound and a defined upper bound describing how accurately the autonomous device has performed the respective task associated with the sample. In certain aspects, reward values that are closer to the defined lower bound may correspond to less accurate performance of the task, and reward values that are closer to the defined upper bound may correspond to more accurate performance of the task relative to an a priori defined target state.

In certain aspects, training the machine learning model may include, for each of the plurality of samples: (i) monitoring one or more actions performed by an agent in an environment to perform the respective task associated with the sample; (ii) based on the monitoring, determining an end state for performance of the respective task; and (iii) assigning a reward signal to the end state for performance of the respective task using the reward function. In certain aspects, the environment is a simulated environment.

In certain aspects, the one or more predicates define at least one relationship between at least a first object in an environment in which the autonomous device is configured to operate and a second object in the environment.

In certain aspects, the one or more predicates define at least one relationship between at least a first action to be performed with respect to at least one object in an environment in which the autonomous device is configured to operate and a second action to be performed with respect to the at least one object in the environment.

In certain aspects, the one or more predicates comprise a set of chained predicates, each of which has to be satisfied in order to achieve the successful attempt to perform the task.

In certain aspects, training the machine learning model includes, for at least one of the plurality of samples, generating a trace illustrating a set of actions to be performed in order to perform the task corresponding to the at least one of the plurality of samples. In this case, the machine learning model may be trained based at least in part on the generated trace. In these aspects, the trace may be generated based on visual content of a human-performed demonstration of the task.

### Example Multimodal Machine Learning Model for Controlling Autonomous Devices

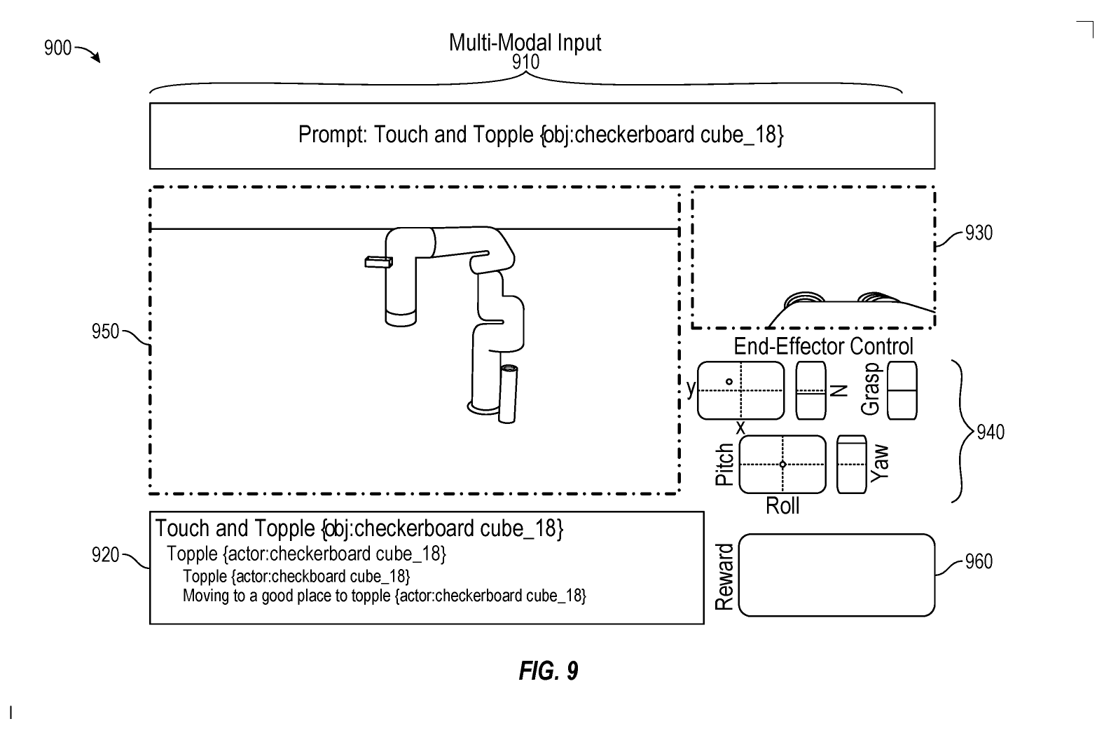

FIG. 9 illustrates an example visualization 900 of a machine learning model (e.g., machine learning model 150) trained to control an autonomous device to perform a task goal, according to certain aspects of the present disclosure. Here, the visualization 900 depicts a multimodal input 910 for the trained machine learning model, visual scene data 930 captured by one or more cameras in an operating environment 950 of the autonomous device (e.g., robot, robotic arm, or other autonomous system), skill trace information 920 for actions identified by the trained machine learning model for the autonomous device to perform, action trajectory information 940 for actions identified by the trained machine learning model for the autonomous device to perform, and reward information 960 for the actions performed by the autonomous device.

In certain aspects, the machine learning model may be end-to-end trained to perform a particular task goal identified in, indicated by, or implied by a multimodal input 910. Here, for example, the multimodal input 910 includes a prompt to touch and topple [obj:checkboard cube_18], where [obj:checkboard cube_18] is an image placeholder representative of the object that is to be touched and toppled within the operating environment 950 of the autonomous device. The trained machine learning model may predict a next action to perform within the environment 950 based on observations (e.g., visual scene data 930 captured by one or more cameras in the environment, depth data gathered within the environment 950, etc.) gathered after performance of other actions within the environment 950. Each action that is predicted by the trained machine learning model may be indicated in the skill trace information 920. Additionally, action trajectories of the autonomous device (e.g., in end effector space) may be indicated in the action trajectory information 940. Further, the reward information 960 may indicate a reward metric generated by the trained machine learning model for each (sub)-task associated with performing the task goal. As noted, the reward metric may indicate whether the autonomous device has successfully performed the (sub)-task. In doing so, aspects of the present disclosure may control robots or other autonomous systems in an autoregressive manner, where the identification of the next action to perform is conditioned on previous actions performed by the robot or other autonomous system and observations of the state of the environment (e.g., positional information associated with different objects in the environment, depth data, etc.) in which these actions are performed.

In certain aspects, the machine learning model may be trained to perform task chaining using existing oracle skills and can learn discrete skills from a priori defined demonstrations of such skills using unsupervised learning techniques. Finally, the machine learning model may be trained using reinforcement learning techniques in which the reward metric is used to tune the machine learning model during training and push the machine learning model towards the selection and execution of tasks that are likely to lead to a successful execution of a task or sequence of tasks defined in a unimodal or multimodal input into the machine learning model.

In another example, aspects of the present disclosure may allow for the evaluation of machine learning models that are trained to generate control signaling to control the performance of tasks in an environment using a robot or other autonomous system. In this example, a base machine learning model may be tuned based on relatively primitive (e.g., elementary) tasks from which composite tasks may be generated. Subsequently, the tuned machine learning model may be used to perform more complex composite tasks, and the reward metric may be used to determine the performance of the tuned model.

By way of example, the trained machine learning model may be evaluated using a multiple-level protocol, which tests the compositional abilities of the trained machine learning model. For instance, in a first level, the machine learning model may be trained on L0 tasks and evaluated both zero-shot and using fine-tuning on L1 tasks and L2 tasks. Additionally, in a second level, the machine learning model may be trained on L0 tasks and L1 tasks and evaluated both zero-shot and using fine-tuning on L2 tasks. At each level, the trained machine learning model may be evaluated on seen and unseen attributes (e.g., objects, textures, and object placements). The environment may also provide partial rewards at each step along with binary success criteria. The success rate and average reward achieved for each task may be monitored and reported.

In some aspects, a machine learning model for controlling actions performed by a robot or other autonomous system may be trained as an instruction-tuned generative artificial intelligence model. Generally, an instruction-tuned generative artificial intelligence model may learn in-context actions not included in a training dataset by observing a small number of other in-context actions. To allow a generative artificial intelligence model to be trained using instruction tuning, a base model may be fine-tuned according to a corpus of demonstration data and annotations of actions performed in the demonstration data. For example, the demonstration data may include videos of humans performing a task or other robots performing a task. Each video (or other demonstration data sample) may be associated with a sequential list of actions depicted in the video in order to perform a task of varying complexity.

The generative artificial intelligence model may subsequently be fine-tuned using the demonstration data to allow the model to understand and map the actions depicted in the demonstration data onto a robot or other autonomous system which is being controlled by the generative artificial intelligence model. At inference time, given an input of a demonstration of a previously unseen task, the generative artificial intelligence model may learn to replicate this task based on prior instruction tuning performed using the demonstration data.

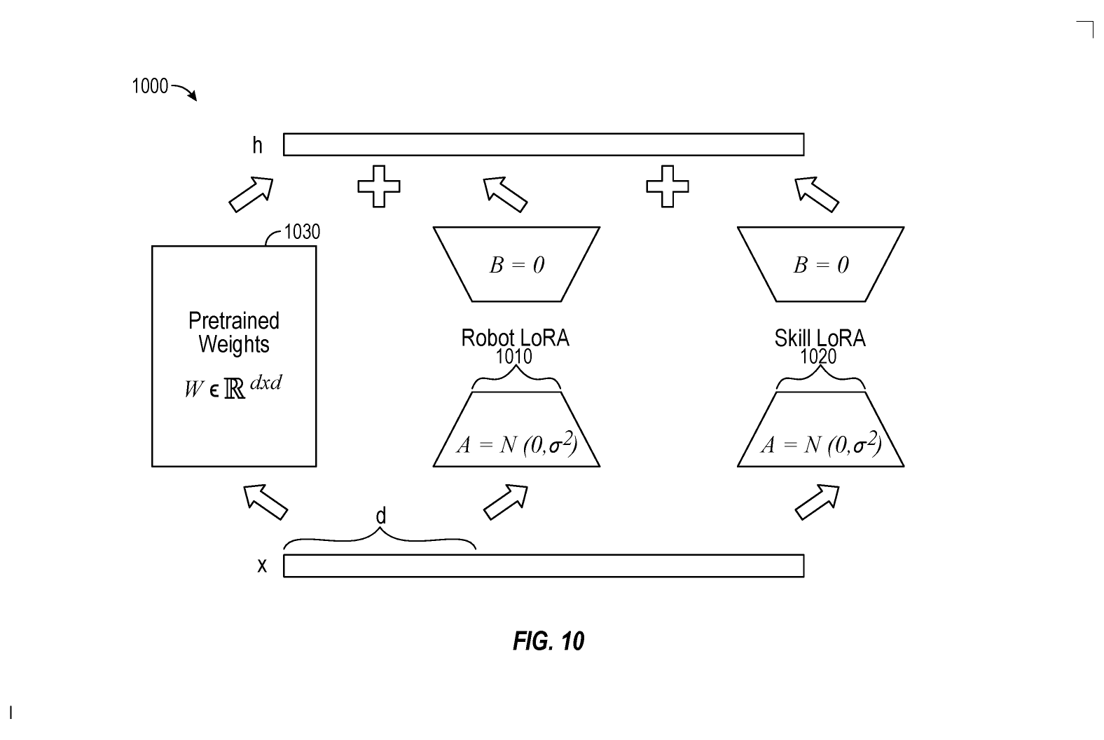

FIG. 10 illustrates an adaptation 1000 of a base machine learning model to perform tasks using an autonomous device, according to certain aspects of the present disclosure.

Low-rank adaptation (LoRA) of machine learning models is a powerful technique that allows a base machine learning model to be adapted to scenarios for which the machine learning model was not previously trained, but which may be similar to tasks or environments in which the machine learning model is deployed. In the context of a robotics foundation model (RFM), which is generally a generative artificial intelligence model trained on a variety of tasks relevant to a variety of robots and may be pre-trained (e.g., with or without natural language-based annotations and using language and/or vision datasets) for downstream users to use in controlling a robot or other autonomous system (e.g., using action primitives and end-effector deltas identifying how an effector of a robot, or other part of a robot which can manipulate an object, is to operate), the RFM may be trained on a specific instance of a robot or other autonomous system and within a specific environment. However, due to properties such as machining tolerances and wear on the robot or other autonomous system, the pre-trained RFM may not generate sequences of actions that allow a specific instance of a robot or other autonomous system to successfully perform a task. Further, different models of robot or other autonomous system may have differing operational characteristics (e.g., dimensions, speed, gear ratios, minimum step size for performing an action, etc.), and thus, the pre-trained RFM may also not accurately generate sequences of actions that allow a model of a robot or other autonomous system different from that used to train the RFM to successfully perform a task.

To allow an RFM to be fine-tuned to perform tasks using a variety of robots or other autonomous systems and in various environments, the adaption 1000 may include a two-stage framework in which the RFM is fine-tuned for a specific robot or other autonomous system (depicted as “Robot LoRA 1010” in FIG. 10) and for a skill or set of skills which the robot or other autonomous system is to perform (depicted as “Skill LoRA 1020” in FIG. 10). To fine-tune the RFM for a specific robot, a set of tasks may be executed using instructions generated by the RFM, and a reward metric representing a comparison between a target state and an observed post-execution state for each task may be captured. Based on the observations, a first set of adaptation weights associated with the robot or other autonomous system may be generated for use, in conjunction with the pre-trained weights 1030 of the RFM, in future inference operations using the RFM.

At the second stage of the adaptation 1000, the RFM may be fine-tuned for specific skills or sets of skills which the model may not have previously been trained to perform. Generally, a skill may represent a specific task which the RFM is to be adapted to perform, while a set of skills may include a set of related skills (e.g., skills involving manipulation of a specific type of object, skills involving a specific type of manipulation of a specific type of object, etc.). To do so, an input indicating (e.g., a prompt defining) a skill or set of skills to be performed by the RFM may be input into the RFM, and an adapter may be trained to adjust the outputs of the RFM based on a triggering event or other triggering data. For example, different adapters may be associated with different tasks, and as the RFM outputs streaming data identifying the tasks which the RFM is to perform or aid in performing, the appropriate adapter may be activated in order to generate control signaling or other instructions to cause the robot or other autonomous system to perform that specific task.

Generally, the adaptation 1000 may be performed continuously, or at least periodically, to allow the RFM to be fine-tuned as conditions change. For example, continuous adaptation of the RFM may allow the RFM to adapt to changing conditions of the robot or other autonomous system to reflect wear and tear on various components of the robot or other autonomous system and thus to compensate (or at least adjust) for changes in how the robot or other autonomous system operates over time. Further, continuous adaptation of the RFM may allow the RFM to continually learn to perform new tasks as such tasks are defined for execution using the RFM.

### Example Operations for Controlling an Autonomous Device to Perform a Task Goal Using a Trained Machine Learning Model

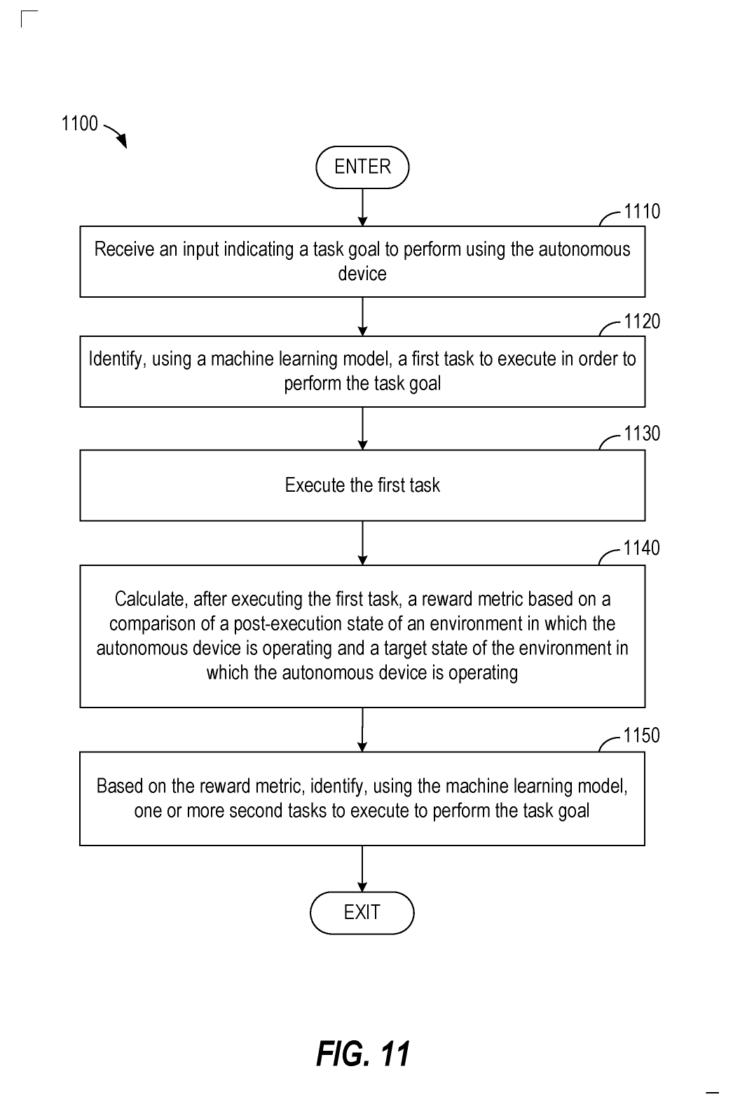

FIG. 11 illustrates example operations 1100 for controlling an autonomous device to perform a task goal identified in an (multimodal) input into a machine learning model, according to certain aspects of the present disclosure. The operations 1100 may be performed on a computing device on which a machine learning model can be deployed to generate instructions or other control signaling used to control the operations of an autonomous system, such as a desktop computer, a laptop computer, a tablet computer, a smartphone, a computing system integrated with the autonomous device, or the like.

As illustrated, the operations 1100 begin at block 1110 with receiving an input (e.g., a multimodal input) indicating a task goal to perform using the autonomous device. The input may include data in one or more modalities (e.g., text, image data, etc.) specifying an action to perform and the objects on which the actions are to be performed. For certain aspects, the input may be a prompt describing the task goal (e.g., a sequence of tasks).

At block 1120, the operations 1100 proceed with identifying, using a machine learning model, a first task to execute in order to perform the task goal.

At block 1130, the operations 1100 proceed with executing the first task.

At block 1140, the operations 1100 proceed with, after executing the first task, calculating a reward metric based on a comparison of a post-execution state of an environment in which the autonomous device is operating and a target state of the environment in which the autonomous device is operating.

At block 1150, the operations 1100 proceed with identifying, based on the reward metric, and using the machine learning model, one or more second tasks to execute to perform the task goal.

In certain aspects, the machine learning model is a generative artificial intelligence model that identifies at least one of the first task or the one or more second tasks in an autoregressive manner. Generally, in autoregressively generating or identifying tasks to perform a task goal indicated by the input (e.g., identified in the input prompt), the machine learning model may identify the next task to perform, conditioned on previous tasks that have been performed during processing of the input and the observed current state of the environment in which the autonomous system is operating. The machine learning model may be trained using the operations 800 of FIG. 8 and/or using any one of or combination of techniques described herein.

In certain aspects, the input includes a multimodal prompt. The multimodal prompt includes data in a plurality of modalities specifying one or more actions to perform and one or more objects on which the one or more actions are to be performed. The plurality of modalities may include text data and image data, as illustrative examples.

In certain aspects, the operations 1100 may proceed with executing the one or more second tasks and evaluating the performance of the one or more second tasks to determine subsequent actions to perform, if any, in order to perform the task goal indicated by the input (e.g., described in the input prompt).

In certain aspects, the operations 1100 may further include localized adaptation, or fine-tuning, of the machine learning model. As discussed, the fine-tuning or adaptation of the machine learning model may allow for the machine learning model to be adapted to control instances or types of an autonomous device different from a base instance of type of the autonomous device which was used in training the machine learning model. The fine-tuning or adaptation of the machine learning model may also allow for the machine learning model to be adapted to perform tasks which the machine learning model was not initially trained to perform. For example, the machine learning model may include a base model with pre-trained weights and an adapter with learnable weights. In this example, identifying the first task may include at least using the adapter to identify the first task.

### Example Processing Systems for Training and Using Machine Learning Models for Controlling Autonomous Devices

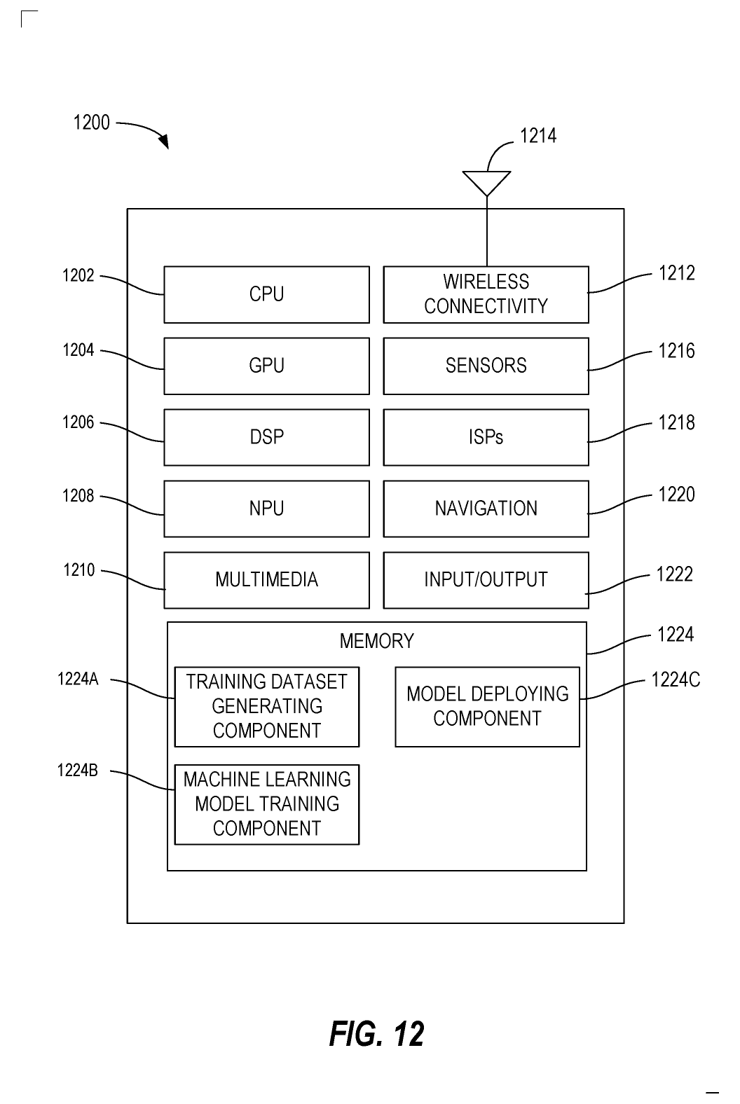

FIG. 12 depicts an example processing system 1200 configured to perform various aspects of the present disclosure, including, for example, the techniques and methods described with respect to FIGS. 1-10. In some aspects, the processing system 1200 may train, implement, or provide a set of machine learning models, illustrated in the workflow 100 of FIG. 1. Although depicted as a single system for conceptual clarity, in at least some aspects, as discussed above, the operations described below with respect to the processing system 1200 may be distributed across any number of devices.

The processing system 1200 includes a central processing unit (CPU) 1202, which in some examples may be a multi-core CPU. Instructions executed at the CPU 1202 may be loaded, for example, from a program memory associated with the CPU 1202 or may be loaded from a partition of memory 1224.

The processing system 1200 also includes additional processing components tailored to specific functions, such as a graphics processing unit (GPU) 1204, a digital signal processor (DSP) 1206, a neural processing unit (NPU) 1208, a multimedia processing unit 1210, and a wireless connectivity component 1212.

An NPU, such as NPU 1208, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1208, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 1208 is a part of one or more of the CPU 1202, the GPU 1204, and/or the DSP 1206.

In some examples, the wireless connectivity component 1212 may include subcomponents, for example, for third generation (3G) connectivity, fourth generation (4G) connectivity (e.g., Long-Term Evolution (LTE)), fifth generation connectivity (e.g., 5G or New Radio (NR)), Wi-Fi connectivity, Bluetooth connectivity, and other wireless transmission standards. The wireless connectivity component 1212 is further coupled to one or more antennas 1214.

The processing system 1200 may also include one or more sensor processing units 1216 associated with any manner of sensor, one or more image signal processors (ISPs) 1218 associated with any manner of image sensor, and/or a navigation component 1220, which may include satellite-based positioning system components (e.g., GPS or GLONASS) as well as inertial positioning system components.

The processing system 1200 may also include one or more input and/or output devices 1222, such as screens, touch-sensitive surfaces (including touch-sensitive displays), physical buttons, speakers, microphones, and the like.

In some examples, one or more of the processors of the processing system 1200 may be based on an ARM or RISC-V instruction set.

The processing system 1200 also includes the memory 1224, which is representative of one or more static and/or dynamic memories, such as a dynamic random access memory, a flash-based static memory, and the like. In this example, the memory 1224 includes computer-executable components, which may be executed by one or more of the aforementioned processors of the processing system 1200.

In particular, in this example, the memory 1224 includes a training dataset generating component 1224A, a machine learning model training component 1224B, and a model deploying component 1224C. Though depicted as discrete components for conceptual clarity in FIG. 12, the illustrated components (and others not depicted) may be collectively or individually implemented in various aspects.

Generally, the processing system 1200 and/or components thereof may be configured to perform the methods described herein.

Notably, in other aspects, components of the processing system 1200 may be omitted, such as where the processing system 1200 is a server computer or the like. For example, the multimedia processing unit 1210, the wireless connectivity component 1212, the sensor processing units 1216, the ISPs 1218, and/or the navigation component 1220 may be omitted in other aspects. Further, components of the processing system 1200 may be distributed between multiple devices.

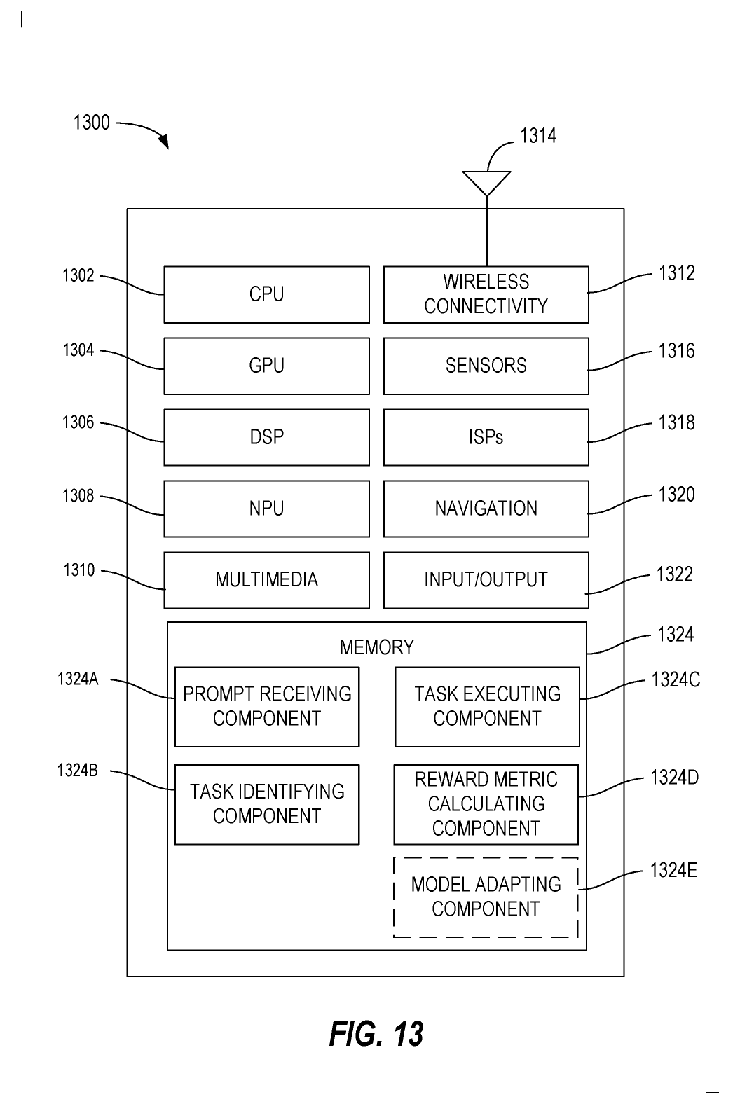

FIG. 13 depicts an example processing system 1300 configured to perform various aspects of the present disclosure, including, for example, the techniques and methods described with respect to FIGS. 1 and 9-11. In some aspects, the processing system 1300 may train, implement, or provide a set of machine learning models, illustrated in the workflow 100 of FIG. 1. Although depicted as a single system for conceptual clarity, in at least some aspects, as discussed above, the operations described below with respect to the processing system 1300 may be distributed across any number of devices.

The processing system 1300 includes a central processing unit (CPU) 1302, which in some examples may be a multi-core CPU. Instructions executed at the CPU 1302 may be loaded, for example, from a program memory associated with the CPU 1302 or may be loaded from a partition of memory 1324.

The processing system 1300 also includes additional processing components tailored to specific functions, such as a graphics processing unit (GPU) 1304, a digital signal processor (DSP) 1306, a neural processing unit (NPU) 1308, a multimedia processing unit 1310, and a wireless connectivity component 1312.

As described above, an NPU, such as NPU 1308, is generally a specialized circuit configured for implementing control and arithmetic logic for executing machine learning algorithms. In some implementations, the NPU 1308 is a part of one or more of the CPU 1302, the GPU 1304, and/or the DSP 1306.

In some examples, the wireless connectivity component 1312 may include subcomponents, for example, for third generation (3G) connectivity, fourth generation (4G) connectivity (e.g., Long-Term Evolution (LTE)), fifth generation connectivity (e.g., 5G or New Radio (NR)), Wi-Fi connectivity, Bluetooth connectivity, and other wireless transmission standards. The wireless connectivity component 1312 is further coupled to one or more antennas 1314.

The processing system 1300 may also include one or more sensor processing units 1316 associated with any manner of sensor, one or more image signal processors (ISPs) 1318 associated with any manner of image sensor, and/or a navigation component 1320, which may include satellite-based positioning system components (e.g., GPS or GLONASS) as well as inertial positioning system components.

The processing system 1300 may also include one or more input and/or output devices 1322, such as screens, touch-sensitive surfaces (including touch-sensitive displays), physical buttons, speakers, microphones, and the like.

In some examples, one or more of the processors of the processing system 1300 may be based on an ARM or RISC-V instruction set.

The processing system 1300 also includes the memory 1324, which is representative of one or more static and/or dynamic memories, such as a dynamic random access memory, a flash-based static memory, and the like. In this example, the memory 1324 includes computer-executable components, which may be executed by one or more of the aforementioned processors of the processing system 1300.

In particular, in this example, the memory 1324 includes a prompt receiving component 1324A, a task identifying component 1324B, a task executing component 1324C, a reward metric calculating component 1324D, and (optionally) a model adapting component 1324E. Though depicted as discrete components for conceptual clarity in FIG. 13, the illustrated components (and others not depicted) may be collectively or individually implemented in various aspects.

Generally, the processing system 1300 and/or components thereof may be configured to perform the methods described herein.

Notably, in other aspects, aspects of the processing system 1300 may be omitted, such as where the processing system 1300 is a server computer or the like. For example, the multimedia processing unit 1310, the wireless connectivity component 1312, the sensor processing units 1316, the ISPs 1318, and/or the navigation component 1320 may be omitted in other aspects. Further, aspects of the processing system 1300 may be distributed between multiple devices.

### Example Clauses

Implementation examples are described in the following numbered clauses:

Clause 1: A processor-implemented method for training a machine learning model to control an autonomous device to perform a plurality of tasks, the processor-implemented method comprising: generating a training data set including a plurality of samples, each of the plurality of samples comprising a task that is performable by the autonomous device and that is mapped to one or more predicates that describe a successful attempt to perform the task; training the machine learning model to control the autonomous device in accordance with an input indicating the plurality of tasks, based on the training data set; and deploying the trained machine learning model.

Clause 2: The processor-implemented method of Clause 1, wherein the input comprises a multimodal prompt comprising text and one or more images.

Clause 3: The processor-implemented method according to any of Clauses 1-2, wherein the input comprises a natural language prompt generated using a trained large language model.

Clause 4: The processor-implemented method according to any of Clauses 1-3, wherein: the one or more predicates are associated with a reward function associated with the task; and the reward function is configured to generate a value between a defined lower bound and a defined upper bound, the value being representative of how accurately the autonomous device has performed the respective task associated with the sample.

Clause 5: The processor-implemented method of Clause 4, wherein training the machine learning model comprises, for each of the plurality of samples: monitoring one or more actions performed by an agent in an environment to perform the respective task associated with the sample; based on the monitoring, determining an end state for performance of the respective task; and assigning a reward signal to the end state for performance of the respective task using the reward function.

Clause 6: The processor-implemented method of Clause 5, wherein the environment is a simulated environment.

Clause 7: The processor-implemented method according to any of Clauses 1-6, wherein the one or more predicates define at least one relationship between at least a first object in an environment in which the autonomous device is configured to operate and a second object in the environment.

Clause 8: The processor-implemented method according to any of Clauses 1-7, wherein the one or more predicates define at least one relationship between at least a first action to be performed with respect to at least one object in an environment in which the autonomous device is configured to operate and a second action to be performed with respect to the at least one object in the environment.

Clause 9: The processor-implemented method according to any of Clauses 1-8, wherein the one or more predicates comprise a set of chained predicates, each of which has to be satisfied in order to achieve the successful attempt to perform the task.

Clause 10: The processor-implemented method according to any of Clauses 1-9, wherein training the machine learning model comprises, for at least one of the plurality of samples, generating a trace illustrating a set of actions to be performed in order to perform the task corresponding to the at least one of the plurality of samples and wherein the machine learning model is trained based at least in part on the generated trace.

Clause 11: The processor-implemented method of Clause 10, wherein the trace is generated based on a visual content of a human-performed demonstration of the task.

Clause 12: A processor-implemented method for controlling an autonomous device with a machine learning model to perform a task goal, the processor-implemented method comprising: receiving an input indicating the task goal to perform using the autonomous device; identifying, using the machine learning model, a first task to execute in order to perform the task goal; executing the first task; after executing the first task, calculating a reward metric based on a comparison of a post-execution state of an environment in which the autonomous device is operating and a target state of the environment in which the autonomous device is operating; and identifying, based on the reward metric and using the machine learning model, one or more second tasks to execute to perform the task goal.

Clause 13: The processor-implemented method of Clause 12, wherein the machine learning model is a generative artificial intelligence model that identifies at least one of the first task or the one or more second tasks in an autoregressive manner.

Clause 14: The processor-implemented method according to any of Clauses 12-13, wherein the input comprises a multimodal prompt.

Clause 15: The processor-implemented method of Clause 14, wherein the multimodal prompt comprises data in a plurality of modalities specifying one or more actions to perform and one or more objects on which the one or more actions are to be performed.

Clause 16: The processor-implemented method of Clause 15, wherein the plurality of modalities comprises text data and image data.

Clause 17: The processor-implemented method according to any of Clauses 12-16, further comprising: executing the one or more second tasks; and evaluating the execution of the one or more second tasks to determine whether one or more third tasks have to be performed in order to perform the task goal.

Clause 18: The processor-implemented method according to any of Clauses 12-17, wherein: the machine learning model comprises a base model with pre-trained weights and an adapter with learnable weights; and identifying the first task comprises using the adapter of the machine learning model to identify the first task.

Clause 19: The processor-implemented method according to any of Clauses 12-18, wherein the machine learning model is trained using the method according to any of Clauses 1-11.

Clause 20: A processing system comprising: a memory comprising processor-executable instructions; and one or more processors coupled to the one or more memories and configured to execute the processor-executable instructions and cause the processing system to perform a method in accordance with any of Clauses 1-11.

Clause 21: A processing system comprising means for performing a method in accordance with any of Clauses 1-11.

Clause 22: A non-transitory computer-readable medium comprising computer-executable instructions that, when executed by one or more processors of a processing system, cause the processing system to perform a method in accordance with any of Clauses 1-11.

Clause 23: A computer program product embodied on a computer-readable storage medium comprising code for performing a method in accordance with any of Clauses 1-11.

Clause 24: A processing system comprising: a memory comprising processor-executable instructions; and one or more processors coupled to the one or more memories and configured to execute the processor-executable instructions and cause the processing system to perform a method in accordance with any of Clauses 12-19.

Clause 25: A processing system comprising means for performing a method in accordance with any of Clauses 12-19.

Clause 26: A non-transitory computer-readable medium comprising computer-executable instructions that, when executed by one or more processors of a processing system, cause the processing system to perform a method in accordance with any of Clauses 12-19.

Clause 27: A computer program product embodied on a computer-readable storage medium comprising code for performing a method in accordance with any of Clauses 12-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for controlling an autonomous device with a machine learning model to perform a task goal, the processor-implemented method comprising:
receiving an input indicating the task goal to perform using the autonomous device;
identifying, using the machine learning model, a first task to execute in order to perform the task goal;
executing the first task;
after executing the first task, calculating a reward metric based on a comparison of a post-execution state of an environment in which the autonomous device is operating and a target state of the environment in which the autonomous device is operating; and
identifying, based on the reward metric and using the machine learning model, one or more second tasks to execute to perform the task goal.

2. The processor-implemented method of claim 1, wherein the machine learning model is a generative artificial intelligence model that identifies at least one of the first task or the one or more second tasks in an autoregressive manner.

3. The processor-implemented method of claim 1, wherein the input comprises a multimodal prompt.

4. The processor-implemented method of claim 3, wherein the multimodal prompt comprises data in a plurality of modalities specifying one or more actions to perform and one or more objects on which the one or more actions are to be performed.

5. The processor-implemented method of claim 4, wherein the plurality of modalities comprises text data and image data.

6. The processor-implemented method of claim 1, further comprising:
executing the one or more second tasks; and
evaluating the execution of the one or more second tasks to determine whether one or more third tasks have to be performed in order to perform the task goal.

7. The processor-implemented method of claim 1, wherein:
the machine learning model comprises a base model with pre-trained weights and an adapter with learnable weights; and
identifying the first task comprises using the adapter of the machine learning model to identify the first task.

8. A processing system for controlling an autonomous device with a machine learning model to perform a task goal, the processing system comprising:
one or more memories comprising processor-executable instructions; and
one or more processors coupled to the one or more memories and configured to execute the processor-executable instructions and cause the processing system to:
receive an input indicating the task goal to perform using the autonomous device;
identify, using the machine learning model, a first task to execute in order to perform the task goal;
execute the first task;
calculate, after the first task is executed, a reward metric based on a comparison of a post-execution state of an environment in which the autonomous device is operating and a target state of the environment in which the autonomous device is operating; and
identify, based on the reward metric and using the machine learning model, one or more second tasks to execute to perform the task goal.

9. The processing system of claim 8, wherein the input comprises a multimodal prompt.

10. A processor-implemented method for training a machine learning model to control an autonomous device to perform a plurality of tasks, the processor-implemented method comprising:
generating a training data set including a plurality of samples, each of the plurality of samples comprising a task that is performable by the autonomous device and that is mapped to one or more predicates that describe a successful attempt to perform the task;
training the machine learning model to control the autonomous device in accordance with an input indicating the plurality of tasks, based on the training data set; and
deploying the trained machine learning model.

11. The processor-implemented method of claim 10, wherein the input comprises a multimodal prompt comprising text and one or more images.

12. The processor-implemented method of claim 10, wherein the input comprises a natural language prompt generated using a trained large language model.

13. The processor-implemented method of claim 10, wherein:
the one or more predicates are associated with a reward function associated with the task; and
the reward function is configured to generate a value between a defined lower bound and a defined upper bound, the value being representative of how accurately the autonomous device has performed the respective task associated with the sample.

14. The processor-implemented method of claim 13, wherein training the machine learning model comprises, for each of the plurality of samples:
monitoring one or more actions performed by an agent in an environment to perform the respective task associated with the sample;
based on the monitoring, determining an end state for performance of the respective task; and
assigning a reward signal to the end state for performance of the respective task using the reward function.

15. The processor-implemented method of claim 14, wherein the environment is a simulated environment.

16. The processor-implemented method of claim 10, wherein the one or more predicates define at least one relationship between at least a first object in an environment in which the autonomous device is configured to operate and a second object in the environment.

17. The processor-implemented method of claim 10, wherein the one or more predicates define at least one relationship between at least a first action to be performed with respect to at least one object in an environment in which the autonomous device is configured to operate and a second action to be performed with respect to the at least one object in the environment.

18. The processor-implemented method of claim 10, wherein the one or more predicates comprise a set of chained predicates, each of which has to be satisfied in order to achieve the successful attempt to perform the task.

19. The processor-implemented method of claim 10, wherein training the machine learning model comprises, for at least one of the plurality of samples, generating a trace illustrating a set of actions to be performed in order to perform the task corresponding to the at least one of the plurality of samples and wherein the machine learning model is trained based at least in part on the generated trace.

20. The processor-implemented method of claim 19, wherein the trace is generated based on a visual content of a human-performed demonstration of the task.
